(19) United States
(12) Patent Application Publication
(10) Pub. No.: US 2008/0250470 A1
(43) Pub. Date: Oct. 9, 2008

(54) System for Video Reproduction in Different Resolutions

(75) Inventors: Wilhelmus Hendrikus Alfonsus Bruls, Eindhoven (NL); Stijn De Waele, Eindhoven (NL); Lincoln Sampaio Lobo, Eindhoven (NL); Henry Van Vugt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,550

(22) PCT Filed: Aug. 28, 2006
(86) PCT No.: PCT/IB2006/052985

§ 371 Date: Mar. 3, 2008

(30) Foreign Application Priority Data
Sep. 6, 2005 (EP) 05108135.4

(51) Int. Cl. H04N 7/173; H04B 1/66

(52) U.S. Cl. 725/139; 375/240.01; 375/E07.001

(57) ABSTRACT

A device for reproducing video data signals receives encoded video data signals; and has a processing unit for decoding the encoded video data signals into the video data signals. The encoded video data signals comprises a base stream of signals (801) representing a standard resolution portion of the video data signals and at least one enhancement stream of signals (802) representing a high-resolution portion of the video data signals. The processing unit has a detection unit for detecting a predefined interlacing mode for the base stream of signals, e.g. non-interlaced or specifically interlaced, and adapting the decoding to decode the base stream of signals in dependence of said detected predefined interlacing mode. Advantageously, the decoding may include vertical filtering to reduce line flicker in re-interlaced video based on the detected non-interlace encoded video signals, or may include reshuffling of encoded video signals based on shuffled video for reducing motion judder in re-interlaced video.

The invention relates to a device for reproducing video data signals, the device comprising input means for receiving encoded video data signals; and processing means for decoding the encoded video data signals into the video data signals, the encoded video data signals comprising a base stream of signals representing a standard resolution portion of the video data signals and at least one enhancement stream of signals representing a high-resolution portion of the video data signals.

The invention further relates to a method for decoding video data signals, the method comprising the steps of receiving encoded video data signals; and decoding the encoded video data signals into the video data signals, the encoded video data signals comprising a base stream of signals representing a standard resolution portion of the video data signals and at least one enhancement stream of signals representing a high-resolution portion of the video data signals.

The invention further relates to a method for encoding video data signals, the method comprising the steps of receiving the video data signals; and encoding the video data signals into encoded video data signals; the encoded video data signals comprising a base stream of signals representing a standard resolution portion of the video data signals and at least one enhancement stream of signals representing a high-resolution portion of the video data signals.

The invention further relates to computer program products for executing the methods.

The invention further relates to a signal assembly, and a record carrier, comprising the encoded video data signals.

Video signal processing systems that utilize storage media having digitally compressed (encoded) video and audio information recorded thereon can give a user a vast number of options for controlling presentation of a program, or a video title, stored on such media. One such system that is gaining rapid popularity comprises a video disc player adapted to process information stored on a DVD (Digital Video Disc or Digital Versatile Disc) record carrier. The current DVD standard supports video images of a maximum resolution of 720×576 lines at 25 Hz or 720×480 lines at 29.97 Hz as used by analog television standards PAL and NTSC, respectively. These television standards are commonly referred to as Standard Definition Television (SDTV).

Recently, digital television standards have been developed to transmit and process high quality video, audio and ancillary data. Among other things, they offer improved picture resolution of e.g. 1920×1080 lines or 1280×720 lines, referred to as High Definition Television (HDTV). In the current document high-resolution video (HDTV) includes high spatial resolution (more pixels per frame) and/or high temporal resolution (more frames per second) when compared to standard resolution video (SDTV).

It is noted that the latest developments in video compression technology could be applied to achieve HDTV resolution video quality at the same bitrate as currently used on SDTV resolution dual-layer DVD discs. If this solution is taken, the HDTV discs can be produced using installed manufacturing processes. In addition, existing drives can be used in the players. The only things that need to be upgraded are the encoding systems in the authoring chain and the decoding chips for the players. Still, the resulting discs are not backward compatible with the installed base of DVD players.

The document WO 03/03474 describes an apparatus for reproducing video data signals, and a record carrier, for reproducing video data signals in a backward compatible way. The apparatus comprises input means for receiving encoded video data signals and processing means for decoding the encoded video data signals into the video data signals. The encoded video data signals comprise a base stream of signals representing a standard resolution portion of the video data signals and at least one enhancement stream of signals representing a high-resolution portion of the video data signals. The apparatus is capable of reproducing high-resolution video data by decoding and combining those streams. Various measures in relation to storing the encoded video data on a record carrier are also described.

Although applying a separate base stream and enhancement stream provides options for backward compatibility, the quality of reproduction at SDTV quality is not fully satisfactory.

It is an object of the invention to provide a video encoding and storage system that accommodates flexible reproduction at various resolutions, and reproduction in interlaced mode, at high quality.

For this purpose, according to a first aspect of the invention, in the device as described in the opening paragraph, the processing means comprise detection means for detecting a predefined interlacing mode for the base stream of signals, and adapting the decoding to decode the base stream of signals in dependence of said detected predefined interlacing mode.

For this purpose, according to a second aspect of the invention, in the method of decoding as described in the opening paragraph, the method comprises detecting a predefined interlacing mode for the base stream of signals, and adapting the decoding to decode the base stream of signals in dependence of said detected predefined interlacing mode.

For this purpose, according to a third aspect of the invention, in the method of encoding as described in the opening paragraph, the encoding is according to a predefined interlacing mode for the base stream of signals, the encoded signals being indicative of the predefined interlacing mode for adapting the decoding of the base stream of signals.

For this purpose, according to a fourth aspect of the invention, in the signal assembly and record carrier as described in the opening paragraph, the base stream of signals are encoded according to a predefined interlacing mode, and the encoded signals are indicative of the predefined interlacing mode for adapting the decoding of the base stream of signals.

The measures according to the invention have the effect that, during reproduction, the specific predefined interlacing mode that has been used for creating the encoded video data signals is detected by the reproduction device. For example, specific predefined interlacing mode is non-interlaced or specifically interlaced. Subsequently, the decoding is adapted to compensate for unwanted effects of the respective interlacing mode used during encoding. Advantageously the quality of the video data signals, after decoding, is improved because the decoding is adjusted to both the specific predefined interlacing mode applied during encoding, and to the display type that is used for reproducing the video data signals.

The invention is also based on the following recognition. The known pre-existing standards for encoded video, such as MPEG2, allow for a non-interlaced mode. Also many displays are of an interlaced type, like common TV displays. Although the non-interlaced encoded video may be used to generate the interlaced video signals, the inventors have seen that such re-interlaced video signals have some quality defects. Hence, a solution is provided based on detecting the interlacing mode that has been used during encoding. Detecting the non-interlaced encoding mode, and correspondingly adapting the decoding, may either be performed in a low-end device for outputting standard resolution, interlaced video, or in a high-end device for outputting high-resolution, non-interlaced video. The devices will adapt the video processing based on the detected predefined interlacing mode. Furthermore, a dedicated encoding mode for the base stream in a specific interlacing mode is proposed to mitigate quality defects on interlaced displays.

In an embodiment of the device the detecting means is arranged for detecting, in the encoded video data signals, a status indicator indicative of the predefined interlacing mode; or detecting, in the encoded video data signals, video parameters indicative of the predefined interlacing mode; or detecting a user command to adapt said decoding to the predefined interlacing mode. The status indicator has the advantage that it directly indicates the predefined interlacing mode that has been used during encoding. Detecting video parameters allows detection of non-interlaced base streams without requiring specific indicators to be included during encoding, at the cost of more complex detection. Finally, allowing a user to instruct the device for adapting the processing, compensates for errors in the automatic detection.

In an embodiment of the device the processing means comprises means for converting, in dependence of said detected predefined interlacing mode, the base stream of signals to interlaced video data signals for display on an interlaced display. Basically re-interlacing is performed by skipping alternating lines. It is noted that the base stream as such may be converted from non-interlaced to interlaced, and the processing may be adapted to the specific predefined interlacing mode. Alternatively, the base stream of signals and the at least one enhancement stream of signals can be both recovered, and first a full rate non-interlaced video signal is generated based on both streams. Subsequently, the respective, alternate lines from each frame are used to generate an interlaced video signal.

In a further embodiment of the device for interlaced output, the processing means comprises filtering means for vertical filtering, in dependence of said detected predefined interlacing mode, for reducing high frequency components in the vertical spatial frequency spectrum of the interlaced video data signals. Surprisingly, the inventors have noted, that a re-interlaced video display based on full vertical frequency range, generates unwanted line flicker. The overall perceived picture quality on the interlaced display appears to be better when the high frequency components in the vertical spatial frequency spectrum are reduced.

In an embodiment of the device the processing means comprises combining means for combining, in dependence of said detected predefined interlacing mode, the base stream of signals and the enhancement stream of signals to non-interlaced video data signals for display on a non-interlaced display. It is noted that both streams may be combined first, and subsequently decoded in a single decoder, or may first be (at least partially) decoded and subsequently combined. Also, the non-interlaced video data signals may further be converted to interlaced signals as discussed above. Combining has the advantage that a high-resolution non-interlaced signal is generated, while the processing takes into account the detected predefined interlacing mode.

In a further embodiment of the device that combines both streams, the processing means comprises reshuffling means for reshuffling pairs of field pictures, the predefined interlacing mode being a mode in which the base stream has been encoded by shuffling field pictures of pairs of consecutive video frames, in a particular case the field pictures being bottom fields of a corresponding interlaced video signal. The inventors have seen that the base stream, when reproduced without enhancements on an interlaced display, lack temporal information This causes so called motion judder, which is detrimental to perceived quality of moving objects. Advantageously, the shuffling results in a base stream that contains full frequency information, e.g. 60 Hz in an NTSC based system. Practically, the bottom fields of a corresponding interlaced signal are exchanged during encoding. By applying the shuffling, legacy devices will show a better quality for interlaced video signals based on the modified base stream. As a consequence, novel high-end devices need to apply the reshuffling for restoring the original sequence of video data.

Further preferred embodiments of devices according to the invention are given in the appended claims, disclosure of which is incorporated herein by reference.

These and other aspects of the invention will be apparent from and elucidated further with reference to the embodiments described by way of example in the following description and with reference to the accompanying drawings, in which

FIG. 1 shows an embodiment of an apparatus for reproducing video data signals,

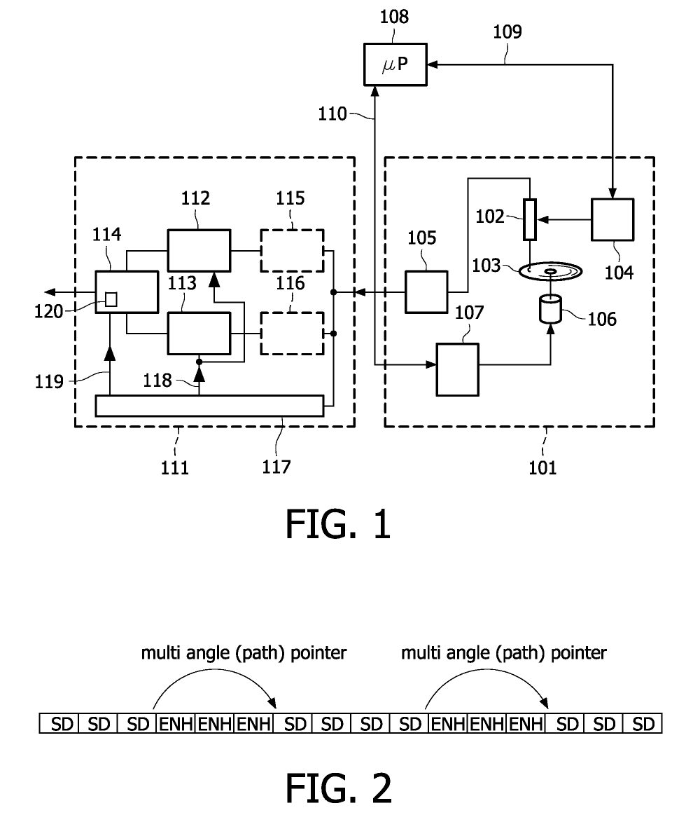

FIG. 2 illustrates interleaving of SD and ENH data by using multi-angle (path) pointers,

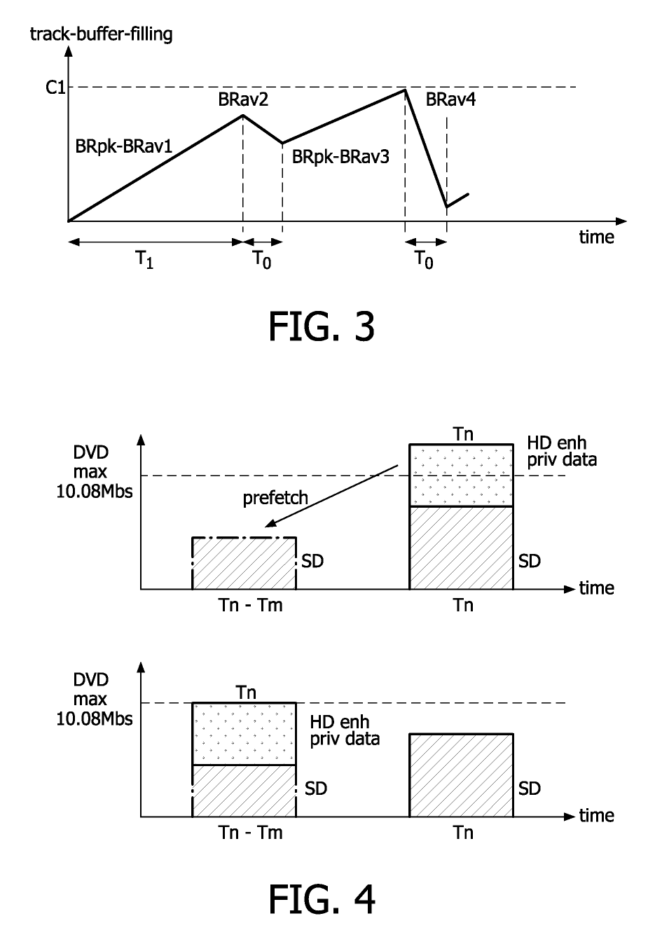

FIG. 3 shows filling of a track-buffer as a function of time,

FIG. 4 illustrates multiplexing of ENH data in the MPEG stream at an earlier time than the corresponding SD data,

FIG. 5 shows an apparatus for reproducing video data signals in an interlaced mode,

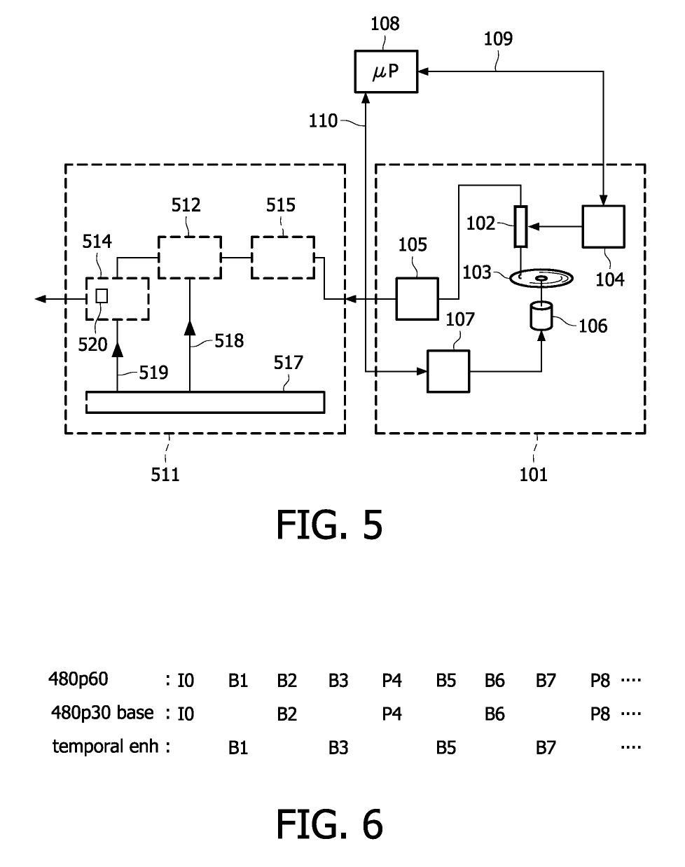

FIG. 6 shows encoded video data signals having a temporal enhancement stream,

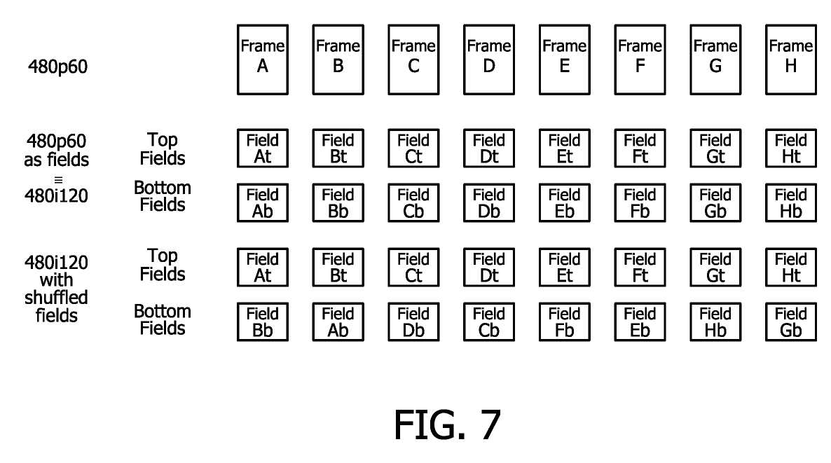

FIG. 7 shows the shuffling fields in a video signal,

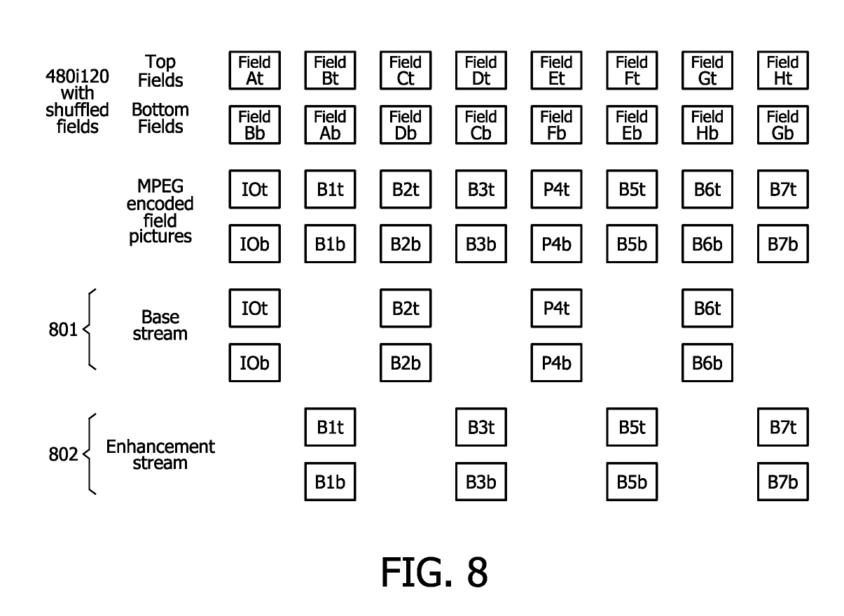

FIG. 8 shows encoding a shuffled video signal to encoded video signals,

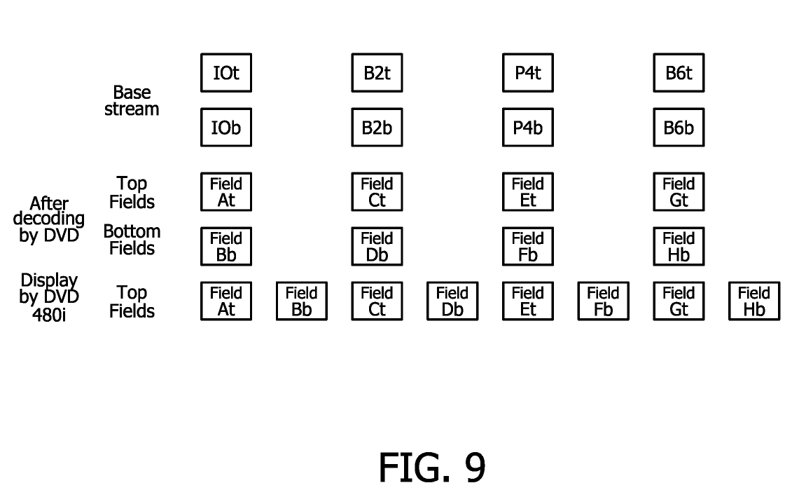

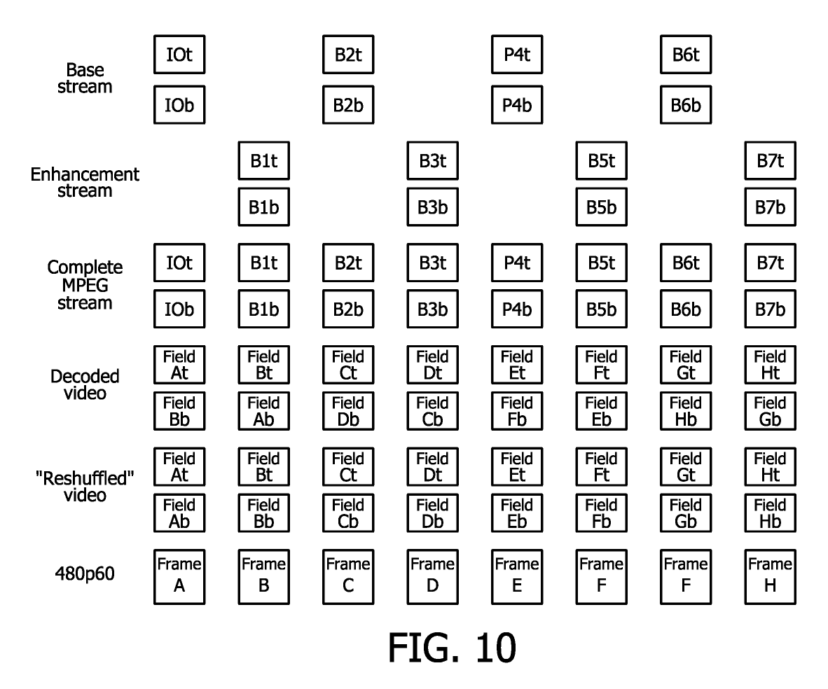

FIG. 9 shows decoding of a base stream based on a shuffled video signal, and

FIG. 10 shows reshuffling of field pictures for reproducing high resolution video.

Corresponding elements in different Figures have identical reference numerals.

FIG. 1 shows an embodiment of an apparatus for reproducing video data signals. The apparatus comprises a read unit 101 for receiving encoded video data signals and a processing unit 111. The processing unit 111 receives the encoded video data signals from the read unit 101 and decodes them into the video data signals. The read unit 101 comprises a read head 102, which is in the present example an optical read head for reading the encoded video data signals from the record carrier 103. Further, positioning means 104 are present for positioning the head 102 in a radial direction across the record carrier 103. A read amplifier 105 is present in order to amplify the signal read from the record carrier 103. A motor 106 is available for rotating the record carrier 103 in response to a motor control signal supplied by a motor control signal generator unit 107. A microprocessor 108 is present for controlling all the circuits via control lines 109 and 110.

The processing unit 111 is adapted to decode the encoded video data signals comprising a base stream of signals representing a standard resolution portion of the video data signals and at least one enhancement stream of signals representing a high-resolution portion of the video data signals, and to combine the standard definition portion and the high resolution portion into the video data signals. The base stream of signals is decoded by a base decoder 112, whereas the enhancement stream of signals is decoded by an enhancement decoder 113. The signals coming from decoders 112 and 113 are combined in a combining unit 114 to form the video data signals of high-resolution. The processing unit may have buffers, e.g. data memory 115 for the base stream of signals and data memory 116 for the enhancement stream of signals.

The input unit 101, or the processing unit 111, may include a de-multiplexer (not shown) for de-multiplexing the base stream of signals and the at least one enhancement stream of signals from a MPEG stream.

According to the invention the processing unit 111 is provided with a detection unit 117 for detecting a predefined interlacing mode for the base stream of signals. The detection unit 117 is coupled via control line 118,119 to the decoder units 112,113 for adapting the decoding to decode the base stream of signals in dependence of said detected predefined interlacing mode. For example, the detection unit 117 may recognize signaling bits included in the encoded video data signals, which do not affect regular DVD players, but can be used to adapt the decoding. For example the detection unit may be arranged for detecting, in the encoded video data signals, a status indicator indicative of the predefined interlacing mode. Alternatively, the unit may detect, in the encoded video data signals, video parameters indicative of the predefined interlacing mode, e.g. by comparing motion information in the encoded video frames. Also, the unit may detect user commands to adapt said decoding to the predefined interlacing mode. The user may know, or may notice from the displayed signals, that the signals are in a non-interlaced mode or in a specific interlaced mode, and correspondingly command the device to adapt the decoding. The processing unit 117 may comprise a reshuffling unit 120 as explained below.

Thus, the processing unit 111 is performing, a method of decoding encoded video data signals, which comprises steps of:

decoding a base stream of signals representing a standard resolution portion of the encoded video data signals;

decoding at least one enhancement stream of signals representing a high-resolution portion of the encoded video data signals,

detecting a predefined interlacing mode for the base stream of signals; and

adapting the decoding to decode the base stream of signals in dependence of said detected predefined interlacing mode.

The encoded video data signals, which are received by the input unit 101, are generated, according to the invention, by a method of encoding video data signals, which comprises steps of:

encoding a base stream of signals representing a standard resolution portion of the video data signals;

encoding at least one enhancement stream of signals representing a high-resolution portion of the video data signals,

the encoding being according to a predefined interlacing mode for the base stream of signals, the encoded signals being indicative of the predefined interlacing mode for adapting the decoding of the base stream of signals.

In a different configuration, e.g. when using video signals in a computer, the methods for encoding and decoding may be performed in a processor of the computer based on software in a program memory. The software may be distributed as a product, e.g. stored on a record carrier, or by downloading via the internet.

The encoding method can be applied for authoring DVD discs using a two (or more) stream approach with scalable compression, of which each compression stream is allocated on a disc separated from each other in such a way, that a standard DVD player can see only the first (basic) stream.

The encoding of video data signals can be modified to include a step of multiplexing the base stream of signals and the at least one enhancement stream of signals within a MPEG stream as explained later in the text.

Advantageously, the input unit 101 can be replaced by an input terminal to receive the encoded video data signals via a cable, Internet or a wireless link. The encoded video data signals may be included in an signal assembly, such as a data file or transmission signal, wherein the encoded video data signals comprise the base stream of signals representing a standard resolution portion of the video data signals, and at least one enhancement stream of signals representing a high-resolution portion of the video data signals. The base stream of signals has been encoded according to a predefined interlacing mode, and the encoded signals are indicative of the predefined interlacing mode for adapting the decoding of the base stream of signals. For example, in the signal assembly, the encoded signals include a status indicator indicative of the predefined interlacing mode.

The processing unit 111 may comprise more than one decoder for decoding more than one enhancement stream; it may also comprise more than one combining unit. Also the processing unit may be arranged for outputting interlaced video, as further described below with FIG. 5. This allows for reproduction of the video data signals having variety of different resolutions.

An embodiment of the recording apparatus is realized by adapting the processing unit 111 to decode the encoded video data signals wherein the base stream of signals and the at least one enhancement stream of signals are encoded using different encoding techniques. For example the base stream can be encoded using MPEG-2 compression technique whereas enhancement streams can be encoded using more advanced methods. This solution provides backward compatibility with the legacy devices. At the same time enhancement streams can be transported with high efficiency.

In a particular implementation, the base decoder 112 is adapted to decode SDTV signals, the enhancement decoder 113 is adapted to decode HDTV surplus signals and the combining unit 114 is adapted to produce HDTV signals.

Advantageously, the read unit 101 can be adapted to receive the encoded video data signals from a DVD optical disc medium.

It is beneficial, if this type of a DVD disc is provided with video data in such a way that legacy DVD players can reproduce the base, Standard Definition (SD) part of video data as from ordinary DVD media. This can be achieved by separating the base data and the enhancement data (ENH) in a number of manners.

One possibility is to interleave these data at the level of video object files (VOBs) as known from the DVD standard. It is possible to use for this purpose multi (camera) angle pointers or multi path pointers. For example SD data may be comprised in default camera angle track and HD surplus data-in an alternate camera angle track. This is illustrated in FIG. 2. Every DVD player has a so-called track-buffer of a predetermined size, e.g. C1 Mb. The encoding and multiplexing of the SDTV stream must be done in such a way that at every separation point there are enough bits in the track-buffer to bridge the gap in time it takes to jump over a block of enhancement sectors. Suppose it takes T₀ seconds for a jump before new SD sectors are read again. During T₀ an average bitrate supplied to decoder is BRₐᵥ. This means that at least T₀*BRₐᵥ bits must be present in the buffer at the moment of jump. The peak rate at which a DVD player can read is BRₚₖ. Reading should be performed at the maximum rate possible, BRₚₖ. During reading we also have to supply the decoder with the needed SD bits, so the track-buffer will grow with a rate BRₚₖ−BRₐᵥ. So generally, the bits build-up during reading the SD sectors, T₁*(BRₚₖ−BRₐᵥ₁), must much with the bits, T₀*BRₐᵥ₂, needed during the jump phase, as schematically shown in FIG. 3. This puts an additional constraint to the SD encoder; it must use this model and its parameters for the regulation of a bitrate and multiplexing.

The input unit 101 can be adapted to receive SD and ENH data streams which are interleaved on the record carrier 103 in the manner described above.

Another way to separate SD and ENH data is to store them on the record carrier 103 in separate files/tracks and adapt the input unit 101 accordingly. In this embodiment the input unit 101 is able to read a block (say for 1 second of video) of SD data very fast and put it in a memory, then jump to the HD surplus data area and read very fast a block (again, say for 1 second of video) of ENH data and put them in memory. In this way the drive keeps alternating reading the SD and ENH sectors. The base decoder 112 and the enhancement decoder 113 can read from this memory. The input unit 101 and the memory are made sufficiently fast and large so that decoders 112 and 113 never run of data and thus are able to deliver an uninterrupted continues HD video data signal. In this scheme, for the interval of 1 second about 2 MB of memory is required.

Yet another option is to put base data representing a standard resolution portion of the video data signals and enhancement data representing a high-resolution portion of the video data signals in different physical layers on the record carrier 103. In this case the input unit 101 is adapted to receive encoded video data signal from a multi-layer optical disc.

In addition to the above, there are other ways to separate SD and ENH data in a backward compatible way at the MPEG stream level: —at the MPEG-2 Program Stream level —at the MPEG-2 (or MPEG-1) elementary stream level.

At the MPEG-2 Program Stream level, the enhancement data can be multiplexed when it is included in a private stream. An embodiment on a DVD disc is to put the ENH data in MPEG private_stream_{—}1 packets with a DVD sub_stream_id (identifier of the respective substream) that is currently reserved. Alternatively, the HD surplus data can be included in the MPEG-2 video elementary stream in extension_and_user_data segments, at a sequence, at group_of_pictures or at a picture level. A drawback of including the additional data directly into the MPEG stream is the DVD standard requirement to restrict the multiplexed rate to 10.08 Mbps. Although the target average for the total data stream is about 8 Mbps (allowing for recording 135 minutes on a dual-layer DVD disc), peak rates can be well above the maximum. Legacy players might fall over if this maximum bitrate is exceeded. Therefore, the allocation rule for the ENH data should be relaxed in such a way that the excess data near the peak rates can be more evenly spread over a wider area in the stream. This can be accomplished by defining the size of the separate buffer, which is required for the ENH data stream in the MPEG-2 system target decoder model, big enough to handle the vast majority of streams. In exception cases peak bitrate problems can be solved by proper preprocessing (filtering) and/or by adjusting the compression rate locally.

FIG. 4 shows multiplexing of ENH data in the MPEG stream at an earlier time than the corresponding SD data. After readout by the input unit 101 this pre-fetched ENH data is kept in an ENH data memory 116 until it is needed by the enhancement decoder 113. Even when the average pre-fetch time offset is as much as 1 minute, the corresponding memory size is still very realistic (60 seconds*2 Mbps<16 MB). In a particular embodiment a faster then 1× drive and optional SD data memory 115 is used.

Separating the SD and HD surplus streams at the MPEG level has a number of advantages:

authoring is relatively simple as the two streams are combined together at the MPEG level immediately after coding. Other stages of the authoring process are hardly affected;

the jump noise in the apparatus is kept low (compared with a solution where the streams are at a greater physical distance);

the MPEG stream including the ENH data can be redistributed without additional processing, using existing standards;

since this MPEG output stream more or less has a Constant Bit Rate behavior, it can be transmitted rather easily over a wireless link.

The enhancement data on the record carrier 103 may be protected by a different technique than the base data, so illegal copies of the record carrier 103 would have video data of worse quality.

FIG. 5 shows an apparatus for reproducing video data signals in an interlaced mode. The apparatus comprises a read unit 101 for receiving encoded video data signals, as described above with FIG. 1, and a processing unit 511.

The processing unit 511 is adapted to decode the encoded video data signals as defined above. The base stream of signals is decoded by a base decoder 512 to a non-interlaced signal. The enhancement stream of signals may also be used by base decoder 512, as explained below. The non-interlaced signals coming from decoder 512 is converted to an interlaced signal in a converter unit 514 to form the video data signals for an interlaced display. The processing unit 511 may have buffers for temporarily storing the encoded video data signals, e.g. data memory 515.

According to the invention the processing unit 511 is provided with a detection unit 517 for detecting a predefined interlacing mode for the base stream of signals. The detection unit 517 is coupled via control lines 518,519 to the decoder unit 512 and converter unit 514 for adapting the decoding to decode the base stream of signals in dependence of said detected predefined interlacing mode. The processing unit 511 may include a filtering unit 520 for vertical filtering as described below.

It is noted that the various configurations of decoder and converter units shown in FIGS. 1 and 5 may be combined in a single device, and may also be performed in different hardware of software structures, e.g. as functional units implemented in firmware using a signal processor.

FIG. 6 shows encoded video data signals having a temporal enhancement stream. The upper row of pictures shows an original encoded video signal in a progressive mode at 60 Hz and a resolution of 480 lines, marked “480p60”. The second row shows a base stream of signals having a progressive mode at 30 Hz and a resolution of 480 lines, marked “480p30 base”. The third row shows an enhancement stream of signals for enhancement of the standard resolution video reproducible from the base stream to temporally enhanced high resolution video. The row is marked “temporal enh”, and only contains video data that is not required for decoding the base stream of signals, e.g. B frames (bi-directional predicted frames according to MPEG).

By the encoded video signals comprising the base and temporal enhancement signals as shown in the second and third row, a low cost SDTV backwards compatible HDTV format is enabled by using temporal scalability and a downscaled progressive 480p @ 60 Hz format. The compatible progressive base layer is formatted as a regular SDTV interlaced format, so legacy player will be able to reproduce a signal. However, the quality of the reproduced signal is not very satisfactory, and is to be enhanced by detecting the interlacing mode used for encoding the base stream, and subsequently adapting the decoding.

For transferring HDTV signals in a compatible way using a limited amount of data, e.g. due to the limited capacity of a DVD disc, a kind of format down-conversion is required, e.g. lowering the resolution from 1920*1080 to 1280*720. The idea is to downscale in such a way that the loss in picture quality is minimal. Another point is that a plain downscaled format is not support by the DVD standard, so it results in the problem that if such a disc is played in normal legacy equipment, no picture at all will produced.

To enable recording times of about 2.5 hrs on a dual layer DVD+R disc (total capacity 8.5 GB) for the video a MPEG2 average rate of 7 Mbs is available. For those bitrates, experiments have shown that downscaling with well known techniques from 1080i (1920*540*2@30 Hz) to 480p (720*480*1@60 Hz) rather than the usual 480i (720*240*2@30 Hz), give a significant picture quality improvement after rendering back to 1080i from these compressed formats. However such a non-interlaced 480p format is not compatible with DVD, which is seen as a big disadvantage.

The idea, as shown in FIG. 6, is to split the 480p60 Hz stream by means of so-called temporal scalability into a 480p30 Hz, which is on disc formatted as a common DVD 480i format. The base stream of signals has I, P and the even B frames, and the enhancement stream of signals contains the odd B frames. This is possible with even numbers for the MPEG2 M-parameter, e.g. M=4 as in FIG. 6.

In order to make sure a legacy DVD player only sees the 480i base, the temporal enhancement video data can be formatted on the disc in several ways. On a DVD the temporal enhancement data may be stored as discussed above with FIGS. 2, 3 and 4, i.e. not visible a for a regular DVD player. Note that the alternating reading principle is preferred because the enhancement stream of signals does not count for the DVD peak bitrate limit of 10 Mbs. In this way the legacy DVD player will be able to correctly the 480p30 Hz base on a (interlace) normal SDTV, although the picture quality is not perfect, inter alia due to line flicker.

The decoding may be adapted to reduce said line flicker. The line flicker results from high frequency components in the interlaced signal, which normally are filtered during encoding interlaced signals. Such filtering during encoding is often named Kell filtering, e.g. described in:
Hsu, S. C., (1986). The Kell Factor: Past and Present. SMPTE Journal—Society of Motion Picture and Television Engineers, 95, 206-214.

The Kell filtering is related to the interlaced scan spatial resolution problem, called interline flicker, that occurs when sequential lines, in alternate interlaced fields, contain a great deal of vertical detail. Interline flicker is 30 Hz in the US, and 25 Hz in Europe, and, when present, is visible when the viewing distance is less than six times the SDTV picture height (three times for HDTV). In the 1930's, when Kell described the effect, this was considered a small price to pay for the reduced transmission bandwidth. Kell filtering gives about 30% vertical resolution loss. Progressive scanning displays are unaffected by interline flicker, but require twice the video signal bandwidth. Hence the progressive video signals are not filtered.

The processing unit 517, according to the invention, first detects the non-interlaced encoding mode of the SDTV signal, which signal appears as an interlaced signal to legacy players. Subsequently, for decoding the base stream of signals, by filtering unit 520, vertical filtering is added to the decoder function for reducing high frequency components in the vertical spatial frequency spectrum of the interlaced video data signals. The filtering is similar to the Kell filtering known from encoding.

For detecting the specific interlacing mode a status flag can be added to the private data area of the (multiplexed) stream of encoded video signals to indicate that this recording is of a special class.

In an embodiment, in response to detecting the special interlacing mode, the device can be arranged to render a full quality normal interlaced SDTV signal by decoding both layers (by implementing a double speed decoder), and subsequently applying the Kell filtering. Converting to an interlaced video signal is performed by re-interlacing, e.g. by skipping alternating lines.

An advantage of this format is that it combines SDTV compatibility with an optimal vertical resolution when reproducing HDTV quality on a non-interlaced display, by encoding to the progressive (non-interlaced) signal 480p60 Hz, where no Kell filter during encoding is applied. Also, for the HDTV recorder/player, the 480p60 Hz signal can relatively easy be converted to other HDTV formats such as 1080i (1920*540*2@30 Hz) or 720p (1280*720*1@60 Hz), while for a good result to such formats, starting from 480i (720*240*2@30 Hz) a quite complex motion compensated de-interlacer would have been required.

In an embodiment the encoding of the interlacing mode could be arranged to apply the so-called ‘natural motion’ principle in order to substantially reduce the size of the B frames in the enhancement stream of signals. This principle is described in WO03/054795. This would lead to a significant reduction of the total bitrate (in practice from ˜7 Mbs to ˜4 Mbs) and allow for increased recording time of HDTV on single layer erasable discs like 4.7 GB DVD+RW.

A further improved embodiment is related to movements of objects in the interlaced video signals. The picture quality of the re-interlaced signals is not fully satisfactory due to motion judder, which is caused by the lack of 50/60 Hz information in re-interlaced signals based on a progressive base stream of signals. For reducing the motion judder, the encoding is adapted by splitting of each frame of the 480p@ 60 Hz signal in 2 field pictures, and a shuffling of the bottom fields within every pair of consecutive frames. Accordingly, the device for reproducing the non-interlaced video is provided with the reshuffling unit 120, as shown in FIG. 1, which performs the reshuffling as explained with FIG. 10.

After generating the base stream of signals and the temporal enhancement stream of signals as shown in FIG. 6, each 480p frame is divided in a top field and a bottom field. The next step is to perform a “shuffling”, by which the bottom fields of every pair of frames are “exchanged”. In this way, after the stream is encoded, the base stream still contains 60 Hz information, avoiding the occurrence of motion judder when decoding the base stream of signals to an interlaced signal.

FIG. 7 shows the shuffling fields in a video signal. The upper row of pictures shows an original encoded video signal as a row of frames in a progressive mode at 60 Hz and a resolution of 480 lines, marked “480p60”. The second row shows a the same data converted to fields of an interlaced video stream at 120 Hz, marked 480i120. Note that the interlaced signal has top fields (At, Bt, . . . ) and bottom fields (Ab, Bb, . . . ) containing even and odd lines to be subsequently displayed. The third row shows the interlaced signal with shuffled fields, notably At combined with Bb and Bt with Ab constituting a pair frames having shuffled fields. The resulting “shuffled” video signal is then MPEG-encoded, i.e. the shuffled frames are encoded, and transmitted as a base stream of signals.

In an embodiment, encoding of the shuffled video signal will be as field pictures. This is due to its construction the more efficient way. However, this is not a strict requirement, and the signal may also be encoded as progressive frames.

Because of the shuffling operation the progressive encoding process will be slightly less efficient than encoding the original 480p60 signal. Like in FIG. 6, the MPEG base stream is formed by taking the I, P and even B pictures, and the MPEG enhancement stream of signals is formed by the odd B pictures.

FIG. 8 shows encoding a shuffled video signal to encoded video signals. The top row, like in FIG. 7, shows an interlaced signal with shuffled fields. The second row shows the MPEG encoded field pictures marked I, P, B as usual. The third row shows a base stream of signals 801 having a progressive mode at 30 Hz and a resolution of 480 lines based on the shuffled video signal. The fourth row shows an enhancement stream of signals 802, which only contains the B frames, based on the shuffled video signal. A legacy DVD player will decode only the base stream (third row), and handle it as a 480i stream.

FIG. 9 shows decoding of a base stream based on a shuffled video signal. The first row shows a base stream of signals having a progressive mode at 30 Hz and a resolution of 480 lines based on the shuffled video signal. The second row shows top and bottom fields after decoding. The third row shows the top fields (of the original 480i20 signal), as displayed on an interlaced 60 Hz display in 480i mode. Because the 60 Hz information is still available (i.e. some information from all the original 480p60 frames is present) no motion judder will be observed.

For decoding the encoded stream of video signals based on the shuffled video signal, in an embodiment of the device for reproducing in high resolution mode, will detect the special shuffled non-interlace mode. The device for HDTV has a decoding unit that comprises combining the base stream of signals and the enhancement stream of signals to non-interlaced video data signals for display on a non-interlaced display, e.g. as shown in FIG. 1. On detecting the shuffled video signal, the decoding is adapted as follows. The combining unit 114 performs reshuffling pairs of field pictures.

FIG. 10 shows reshuffling of field pictures for reproducing high resolution video. The top row shows a base stream of signals having a progressive mode at 30 Hz and a resolution of 480 lines based on the shuffled video signal. The second row shows an enhancement stream of signals, which only contains the B frames, based on the shuffled video signal. The third row shows the complete MPEG stream after combining both streams, while the fourth row shows the video after decoding, still in shuffled state. The fifth row shows the reshuffled video, as created by re-ordering the bottom fields, e.g. in a buffer memory. Finally, the sixth row shows the resulting video in high resolution progressive format, i.e. 480p60 mode. Hence, in a HDTV player, the base and enhancement streams are decoded and combined. The decoded video is then “reshuffled”, in order to pair again fields that originally belonged to the same 480p60 frame. The pairs of fields are combined to reconstruct the original 480p60 frames (marked A, B, C, . . . ).

Although the invention has been explained mainly by embodiments that separate temporal enhancement streams, the invention may similarly be applied to other enhancement streams such as resolution enhancements. Furthermore, the examples are based on CD, or DVD dual layer record carriers, but any record carrier, or transmission medium, is suitable for implementing the invention.

Further it is noted, that in this document the word ‘comprising’ does not exclude the presence of other elements or steps than those listed and the word ‘a’ or ‘an’ preceding an element does not exclude the presence of a plurality of such elements, that elements of the control unit discussed in the above may be present in hardware and/or software in different devices, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for reproducing video data signals, the device comprising:
input means (101) for receiving encoded video data signals; and
processing means (111) for decoding the encoded video data signals into the video data signals;
the encoded video data signals comprising a base stream of signals representing a standard resolution portion of the video data signals and at least one enhancement stream of signals representing a high-resolution portion of the video data signals,
the processing means (111,511) comprising detection means (117,517) for
detecting a predefined interlacing mode for the base stream of signals, the predefined interlacing mode including at least one of non-interlaced or specifically interlaced, and
adapting the decoding to decode the base stream of signals in dependence of said detected predefined interlacing mode.

2. Device as claimed in claim 1, wherein the detecting means (117,517) is arranged for
detecting, in the encoded video data signals, a status indicator indicative of the predefined interlacing mode; or
detecting, in the encoded video data signals, video parameters indicative of the predefined interlacing mode; or
detecting a user command to adapt said decoding to the predefined interlacing mode.

3. Device as claimed in claim 1, wherein the processing means (517) comprises means (514) for converting, in dependence of said detected predefined interlacing mode, the base stream of signals to interlaced video data signals for display on an interlaced display.

4. Device as claimed in claim 3, wherein the processing means (517) comprises filtering means (520) for vertical filtering, in dependence of said detected predefined interlacing mode, for reducing high frequency components in the vertical spatial frequency spectrum of the interlaced video data signals.

5. Device as claimed in claim 1, wherein the processing means (117) comprises combining means (114) for combining, in dependence of said detected predefined interlacing mode, the base stream of signals and the enhancement stream of signals to non-interlaced video data signals for display on a non-interlaced display.

6. Device as claimed in claim 5, wherein the processing means (117) comprises reshuffling means (120) for reshuffling pairs of field pictures, the predefined interlacing mode being a mode in which the base stream has been encoded by shuffling field pictures of pairs of consecutive video frames, in a particular case the field pictures being bottom fields of a corresponding interlaced video signal.

7. Device as claimed in claim 1, wherein the input means (101) comprise reading means (102,104,105,106,107) for retrieving the encoded video data signals from a record carrier (103).

8. Method for decoding video data signals, the method comprising the steps of
receiving encoded video data signals;
decoding the encoded video data signals into the video data signals;
the encoded video data signals comprising a base stream of signals representing a standard resolution portion of the video data signals and at least one enhancement stream of signals representing a high-resolution portion of the video data signals,
detecting a predefined interlacing mode for the base stream of signals, the predefined interlacing mode including at least one of non-interlaced or specifically interlaced; and
adapting the decoding to decode the base stream of signals in dependence of said detected predefined interlacing mode.

9. Method for encoding video data signals, the method comprising the steps of
receiving the video data signals;
encoding the video data signals into encoded video data signals;
the encoded video data signals comprising a base stream of signals representing a standard resolution portion of the video data signals and at least one enhancement stream of signals representing a high-resolution portion of the video data signals,
the encoding being according to a predefined interlacing mode for the base stream of signals, the the predefined interlacing mode including at least one of non-interlaced or specifically interlaced, encoded signals being indicative of the predefined interlacing mode for adapting the decoding of the base stream of signals.

10. Method as claimed in claim 9, wherein the encoding comprises the step of including, in the encoded video data signals, a status indicator indicative of the predefined interlacing mode.

11. Method as claimed in claim 9, wherein the encoding comprises the steps of
shuffling field pictures of pairs of consecutive video frames, in a particular case the field pictures being bottom fields of a corresponding interlaced video signal, and
forming the base stream of signals in the predefined interlacing mode by including video frames having said shuffled field pictures.

12. Signal assembly for reproducing video data signals, the signal assembly comprising encoded video data signals to be decoded into the video data signals;
the encoded video data signals comprising
a base stream of signals (801) representing a standard resolution portion of the video data signals, and
at least one enhancement stream of signals (802) representing a high-resolution portion of the video data signals,
the base stream of signals being encoded according to a predefined interlacing mode, the predefined interlacing mode including at least one of non-interlaced or specifically interlaced, and
the encoded signals being indicative of the predefined interlacing mode for adapting the decoding of the base stream of signals.

13. Signal assembly as claimed in claim 12, wherein the encoded signals include a status indicator indicative of the predefined interlacing mode.

14. Record carrier (103) carrying encoded video data signals to be decoded into video data signals;
the encoded video data signals comprising
a base stream of signals representing a standard resolution portion of the video data signals, and
at least one enhancement stream of signals representing a high-resolution portion of the video data signals,
the base stream of signals being encoded according to a predefined interlacing mode, the predefined interlacing mode including at least one of non-interlaced or specifically interlaced, and
the encoded signals being indicative of the predefined interlacing mode for adapting the decoding of the base stream of signals.

15. Record carrier (103) as claimed in claim 14, wherein the encoded signals include a status indicator indicative of the predefined interlacing mode.

16. Computer program product for decoding video data signals, which program is operative to cause a processor to perform the method as claimed in claim 8.

17. Computer program product for encoding video data signals, which program is operative to cause a processor to perform the method as claimed in claim 9.
